(19) United States
(12) Patent Application Publication
(10) Pub. No.: US 2008/0055085 A1
(43) Pub. Date: Mar. 6, 2008

(54) System and a Method for Improving the Performance of Rfid Systems

(75) Inventors: Jacob Samboursky, Herzelia (IL); Uri Rutshtein, Kfar Saba (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: MENTA NETWORKS LTD., HERZELIA ISRAEL (IL)

(21) Appl. No.: 11/571,897

(22) PCT Filed: Sep. 26, 2005
(86) PCT No.: PCT/IL05/01027

§ 371 Date: Jan. 10, 2007

Related U.S. Application Data
(60) Provisional application No. 60/613,184, filed on Sep. 27, 2004.
(60) Provisional application No. 60/613,185, filed on Sep. 27, 2004.

(51) Int. Cl. G08B 13/14

(52) U.S. Cl. 340/572.1

(57) ABSTRACT

The present invention is an innovative system and method for managing RFID elements which provides a solution for improving the efficiency, reliability and security of RFID systems. From the stand point of the users, the proposed system provides a unified interface to the raw data, giving them full and continuous access to all tags in a given RFID system. The invention enables operating a RFID system in diverse and less than optimal conditions which would otherwise compromise the integrity of the data. For instance, the proposed solution can achieve high degrees of accuracy in environments where liquid and metal distractions tender tags otherwise unreachable. In addition, the system provides means for successfully accomplishing transference of advance commands such as read, write, lock and suspend to tags which are in noisy and multi tag environments, as well as tags which are in motion or are in remote distances from a reader.

### FIELD OF THE INVENTION

The present invention relates in general to systems and methods for improving the performance of RFID systems and more particularly it relates to systems and methods for improving the performance of RFID systems by establishing means for RFID networks management.

### BACKGROUND

The use of radio frequency identification (RFID) systems is gaining momentum as the leading technology to mark, trace and monitor items. However, to date, the performance of RFID infrastructure, typically build of RFID transceivers (readers), RFID transponders (tags), middleware and an enterprise resource planning (ERP) means, is poor in many cases. Shortcomings of existing RFID systems relate to their insufficient efficiency, low levels of accuracy and potential security breaches. Insufficient efficiency stems from the inability of RFID systems to identify and operate tags quickly, at predetermined time and with high levels of success; low levels of accuracy of the RFID systems relate to its inability to ensure successful tag operation; and the potential security breaches are caused by the fact that current-day RFID systems may be easily monitored and manipulated by unauthorized sources.

The insufficient levels of efficiency of existing RF systems are largely due to the nature of radio frequency (RF) communication used in such systems. The RF communication between the readers and the tags may be blocked by moving object, interfered by RF noise of electrical equipment, interference by other tags in the vicinity and by RF reflections. Since tags are most often placed on mobile object, the communication with the tag may be lost when its object is moved out of the communication range of the readers. As a result, the time needed to complete a command or to identify a tag relatively long and indeterminist: an operation can take any time from a few milliseconds to 10s of seconds in the same environment. Such inefficiencies cause delay, bad performance and add unnecessary complexity to upper level applications. The same RF communication limitations cause the RFID infrastructure to operate in low levels of accuracy. The common phenomenon is unidentified (missed) tags, which cause improper item tracking. Poor accuracy might also lead to missed write and read operations.

To-date, RFID infrastructure is not protected of various security and privacy threats. Such threats could be, for instance, unauthorized identification of items, improper usage of read-write operation and unauthorized operations. Thus, as organization uses RFID tags to tag items any person with a RFID reader may walk into their premises and get a clear map of the quantities of equipment, the location, the model numbers and other sensitive information. In addition, as retail stores tag products with RFID tags, tag information could be used by unauthorized readers, to track the private individual shopping habits, without the permission of the individual. In some cases, security and/or privacy concerns prevent the quick embrace of RFID.

An additional shortcoming of existing RFID systems derives from the fact that RFID technology today relies on multi-directional, strait-forward RF broadcast. This operation is very expensive in terms of broadcasting radiation. Using such techniques in limited environments, although problematic, is still feasible. Using such techniques in a truly ubiquitous nature is infeasible in terms of exposure to RF radiation and the related health hazards. Today, the regulators are defining the rules and limitations for the RF frequency and amplitude used for RFID. However, this effort is not enough; it must be combined with mechanisms for improving the usage of the limited RF resources that are granted for any application.

Another problem which RFID systems face is due to the wide range of tags which are in the market today. Various tags have different capabilities, such as read-write capabilities, various numbers of pages in memory, different memory sizes. While current-day RFID readers can overcome protocol-related issues, in the current method of operation higher-level systems need to handle the different variations tag capabilities and to accommodate the desired operation accordingly. In addition the limited memory of the RFID tags poses severe limitations on the amount of information which may be stored on each tag.

Many potential RFID applications rely on its alleged ability to accurately determine the location of tagged items. However, today's RFID technology cannot be used to achieve such goal. For example, RFID based electronic shelving is still expensive and inaccurate mainly due to limited range, RF reflections and RF interferences issues.

Known in the art are many solutions for the aforementioned shortcomings. On the whole, such solutions address each particular problem individually. There is therefore a need for a comprehensive solution which can address all of them and enable establishing efficient, accurate and secure RFID systems. Such solution should also enable the implementation of advanced functionality and extensive implementations for RFID systems.

### SUMMARY

Disclosed is a system for managing radio frequency identification (RFID) elements communicating with RFID readers. The system is comprised of an on-site software component residing on a computing device for centralizing real time communication between RFID readers in a single geographic location. The communication includes collecting and integrating all data gathered by the RFID readers. The system provides an interface module enabling users to communicate directly with the RFID tag through the on-site software component independent of the activation of any specific reader.

The system also includes a control module for dynamic real time synchronization between RFID readers, and a logical layer module which holds updated information of RFID elements data status and activities of both communicable and incommunicable RFID elements. The on-site module controls command transference characteristics of the RFID readers to optimize the operation of the local RFID system. Also in the scope of the present invention is a central server which communicates with at least one central computing device. Each central computing device manages the RFID elements located at different geographic locations (domains). The central server enables the management and control of all RFID data as represented in the logical layer.

The logical layer module also includes virtual memory representing extended memory of read write RFID elements, and a command buffering algorithm enabling the control of the transmission of commands to the RFID tags in accordance with configured conditions for ensuring the arrival of commands to the RFID tags.

The system may also include a designated RFID time division multiplexing (TDM) communication module or a designated RFID frequency division multiplexing (FDM) communication module for managing the communication of the RFID readers. The algorithms are implemented by designated middleware modules which dynamically define the timing or frequency of the RFID readers, in accordance with optimization calculations. In addition, the system may also include a polarity adjustment module for preventing mutual interference between different RFID readers.

The on-site software module may include an allocation module for dividing particular operations between the different RFID readers. The allocation module, according to which each reader performs a segment of a given operation, is based on a learning algorithm for dynamically selecting optimal communication patterns in any given situation.

The system may also comprise an organization module which defines hierarchical relations between the RFID elements. The hierarchical relations represent logical relations between the objects to which the RFID elements are attached. The RFID elements at the upper levels of the hierarchical relations are enabled to automatically store data relating to lower level RFID elements associated with the upper level RFID elements. The RFID elements which store information of the lower level elements can be updated with data by a designated module.

The system includes a security module for encrypting the communication between the RFID readers and RFID tags. The security measures provided by the system also include an intrusion detection module and an intrusion prevention module for automatic prevention of unauthorized operations of RFID readers in the region. The security module enables defining a multi-level authorization procedure for the communication between the RFID readers and the RFID tags.

Also in the scope of the present invention is a method for managing radio frequency identification (RFID) tags communicating with RFID readers. The method comprises the steps of centralizing real time communication between RFID readers in a single geographic location and collecting and integrating all data gathered by said RFID readers. The method also includes the step of holding updated information of RFID elements data status and activities of both communicable and incommunicable RFID elements, and of dynamically synchronizing in real time between the RFID readers.

### BRIEF DESCRIPTION OF THE DRAWINGS

These and further features and advantages of the invention will become more clearly understood in the light of the ensuing description of a preferred embodiment thereof, given by way of example, with reference to the accompanying drawings, wherein—

FIG. 1 is an illustration of the disclosed RFID environment according to the preferred embodiments of the present invention;

FIG. 2 is an illustration of the dual-layer network according to the preferred embodiments of the present invention;

FIG. 3 is an illustration of the connectivity between different domains according to a first embodiment of the present invention;

FIG. 4 is an illustration of the connectivity between different domains according to a second embodiment of the present invention;

FIG. 5 is an illustration of the RFID time division multiplexing communication algorithm in accordance with one embodiment of the present invention;

FIG. 6 illustrates an example of multi-tier tags in a logistics or retail environment.

### DETAILED DESCRIPTION OF THE PREFERRED EMBODIMENTS

The present invention is a new and innovative system and method for managing radio frequency identification (RFID) elements. The preferred embodiments of the present invention integrate several components and methods to overcome shortcomings of prior art, which enables it to provide a solution for improving the efficiency, reliability and security of RFID systems. From the stand point of the users, the proposed system provides a unified interface to the raw data, giving them full and continuous access to all RFID transponders (tags) in a given RFID system. The disclosed system and method enables operating a RFID system in diverse and less than optimal conditions which would otherwise compromise the integrity of the RFID data. For instance, the proposed solution can achieve high degrees of accuracy in environments where liquid and metal distractions render RFID tags, especially in ultrahigh frequency (UHF) RFID systems, otherwise unreachable. In addition, the system provides means for successfully accomplishing transference of advance commands such as read, write, lock and suspend to RFID tags which are in noisy and multi-tag environments, as well as tags which are in motion or are in remote distances from a RFID transceiver (reader).

According to the proposed solution, the disclosed system and method manage the RFID communication between the RFID readers and the RFID tags through a dual-layer network. The network is managed through a logical layer, which is on top of the communication layer, and holds data of network status and activities. The dual layer configuration rids the upper-level systems from the need to relate to lower-level communication status, relating to all RFID tags in the environment, whether they are temporarily communicable or incommunicable. It also enables developing complex universal RFID data processing applications, which may operate in diverse RFID systems, including RFID tags of multiple vendors and with differing capabilities.

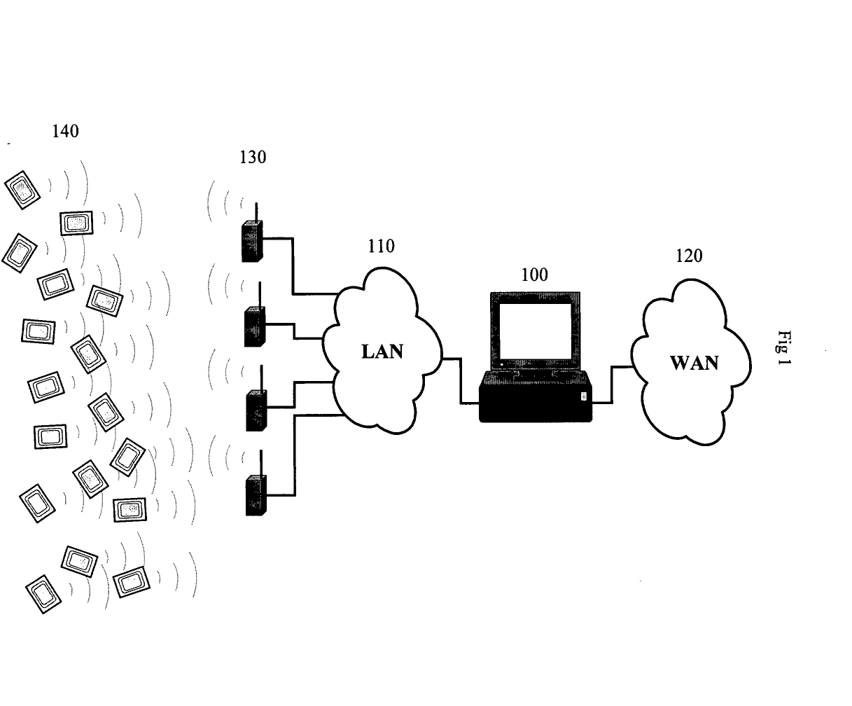

According to the disclosed system and method, each geographic location is defined as a domain, whereas each domain is a single logical entity. An on-site software component collects all data in the domain in real-time, manages communication between RFID readers and controls command transference characteristics to different RFID tags to optimize the operation of the local RFID system. FIG. 1 is a schematic illustration of the disclosed RFID system according to the present invention. The software component operates on a computer 100, or an alternative CPU based electronic device, which communicates with the RFID readers 130 using conventional communication means 110, such as a local area network (LAN), a wireless LAN (WLAN) or serial communications such as RS232. As with conventional RFID systems the RFID readers 130 communicate with the RFID tags through RF transmissions. Using this software component the system may be implemented using any type of RFID readers 130 and corresponding RFID tags 140. The software component controls the operation of the RFID readers 130 using a protocol which is especially designed to operate with a particular type of RFID readers according to the needs of the system at any site. The computer 100 may also connect to a wide area network 120 and communicate with other systems.

The logical layer of each domain holds updated information about all identified RFID tags in that domain. Each domain includes several entry and exit points. Whenever a new RFID tag is identified at an entry point, it is added to the list of RFID tags in the logical layer of the domain and when a known RFID tag is recognized at an exit point, it is removed from that list of RFID tags. This method of operation ensures that an accurate and comprehensive representation of all RFID tags is constantly available for every domain, even if not all RFID tags may be communicated with at every point in time.

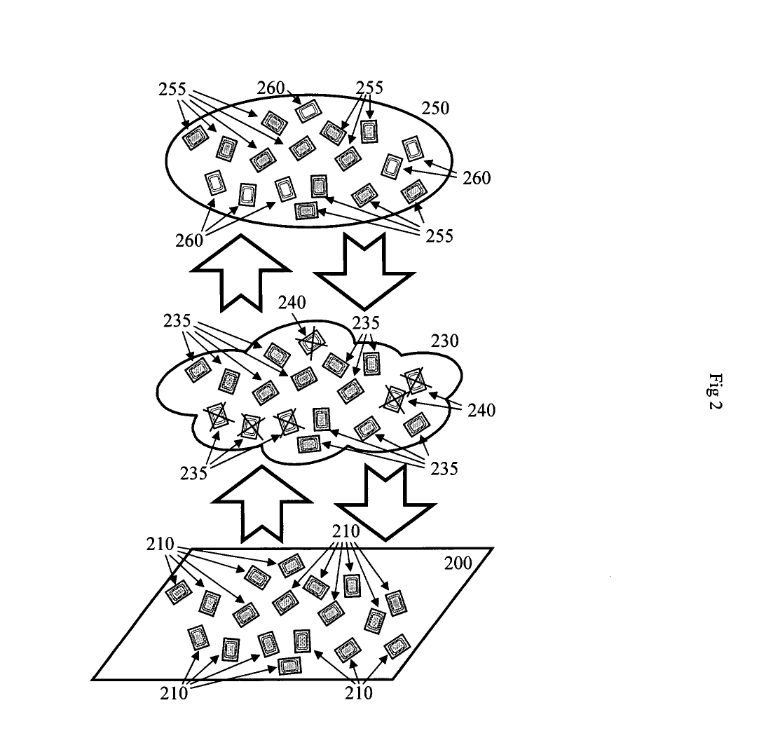

FIG. 2 is a schematic illustration of the dual-layer network according to the preferred embodiments of the present invention. Layer 200 represents the physical layer of the RFID system. It is a single geographic location in which there are multiple RFID tags 210. Layer 230 is the RFID communication layer; it represents the communication status of the RFID tags at a given moment. Since the communication between any RFID tag and the RFID readers in its vicinity may be interfered, there are two types of RFID tags in the communication layer: communicable RFID tags 235 and incommunicable RFID tags 240. There are several prevalent causes which may interfere with the communication between the RFID tags and the RFID readers: the communication may be temporarily blocked by moving objects, interfered by RF noise generated by electrical equipment, by RF reflections or simply the communication of other RF tag in their close vicinity. In any point in time any of the RFID tags may be communicable 235 or incommunicable 240. Communication layer 230 maintains a connection with the communicable RFID tags 235 which are currently available for the RFID transmissions in that area. In the illustrated example of FIG. 2, due to communication interferences between the RFID tags and the RFID readers, while there are 15 RFID tags 205 in the physical layer 200, only 10 RFID tags 235 are communicable at this point in time.

The third layer is the virtual layer 250. This layer holds information about all RFID tags in the area for both communicable RFID tags 255 and the incommunicable RFID tags 260. It is important to note that since all RFID tags are represented in the virtual layer 250, the system may relate to all the RFID tags which exist in the physical layer, whether they are communicable or incommunicable at a any given moment. The system therefore holds constantly updated real-time information about all RFID tags in the domain, including their status and location, without having to rely on having continuous communication with them. The system could also simulate communications to all tags, including incommunicable tags, thus eliminating RF interference issues from higher level systems.

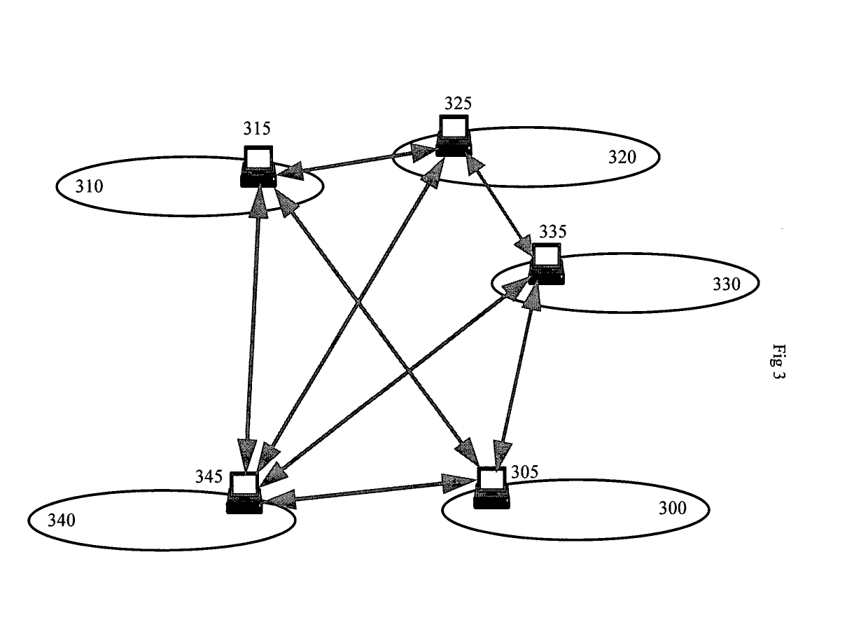

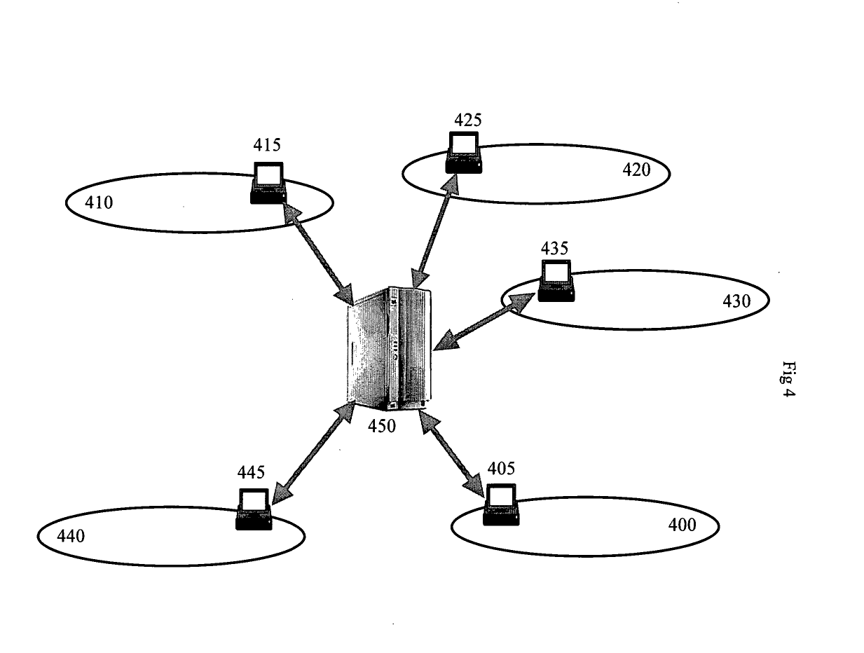

FIG. 3 and FIG. 4 illustrate two possible embodiments of the configuration of the inter-connectivity between the different domains according to the present invention. According to the first embodiment, illustrated in FIG. 3, all the domains of the system 300, 310, 320 and 340 communicate with one another through their corresponding front-end gateways 305, 315, 325, 335 and 345. In the second embodiment, illustrated in FIG. 4, all domains 400, 410, 420 and 440 communicate with a central server 450, such as a file transfer protocol (FTP) server through their corresponding front-end gateways 405, 415, 425, 435 and 445. The central server manages the transference of information between them. These two embodiments are only exemplary embodiments. Any other configuration of connectivity between the different domains is also in the scope of the present invention. It is important to note that these configurations differ from common configurations of RFID systems. Unlike prior art, in which each domain processes its information and transfers only high-level data, according to the disclosed RFID system the domains may share low-level information between them, and data processing may be performed centrally. Thus, if domain 310 is a warehouse and domain 340 is a shop, an item holding a RFID tag which is transferred from the warehouse to the shop is recognized by the system as the same entity.

The dual-layer operation of the system allows it to improve the performance of the RFID system using extensive virtual features. The system may implement RFID tag standardization capabilities in cases where RFID tags with diverse capabilities are used in the same environment. Thus, the upper level of the system may not need to adjust to various RFID tags. In order to implement standardization of the RFID tags, the type and capabilities of each RFID tag is registered in the RFID tag table to ensure that the proper adjustments are activated. For example, the system may simulate read-write capabilities for simple read-only RFID tags using the virtual representation of the RFID tags in the virtual layer. Additionally, the system may utilize a virtual memory mechanism to extend the amount of available memory to read-write RFID tags. The configuration of the system in which the different domains may share low-level data allows it to ensure the coherence of RFID tag information while using shared memory and tag standardization methods. If, for instance, a particular RFID tag is moved from one domain to the next, all the virtual information gathered about it is transferred to its new domain, and loss of information is prevented.

The dual layer mode of operation allows the disclosed RFID system to implement methods for improving the communication abilities between the RFID readers and the RFID tags. One such method is a command buffering algorithm. The commands from the higher levels of the system are not necessarily transmitted to the RFID tags immediately, but are held by the system until particular predefined conditions are met. Such conditions may be configured to ensure the successful operation of the command transference, e.g. the command is transmitted to a RFID tag only after it was identified by a RFID reader, and then it is performed via that reader. The command is deleted from the system after receiving a confirmation for the successful transmission. When a RFID tag is identified at an exit point, all buffered commands are transmitted to it without delay.

To ensure an efficient operation of the system the communication between the RFID readers in any particular domain is centrally managed to avoid collisions and mutual interference. According to one embodiment of the present invention a designated RFID time division multiplexing (TDM) communication algorithm is used. The operation of the RFID tag is divided to two stages of first collecting energy from the transmitting RFID reader(s), and only when level exceeds a predefined level the RFID tag may transmit its ID and/or write in respond to various commands. During the first stage, RF transmission from multiple sources may reduce response time, and in some cases may determine whether a tag is activated at all. During the second stage, the RFID tag needs to synchronize with the clock of the relevant RFID reader. Since each RFID reader has an independent clock, the simultaneous operation of multiple readers at the second stage does not improve their communication abilities, and it may actually interfere with their operation. Thus, the underlying principle behind the RFID TDM approach is the ability to leverage multiple reader benefits in the first stage, while preventing mutual interference in the second.

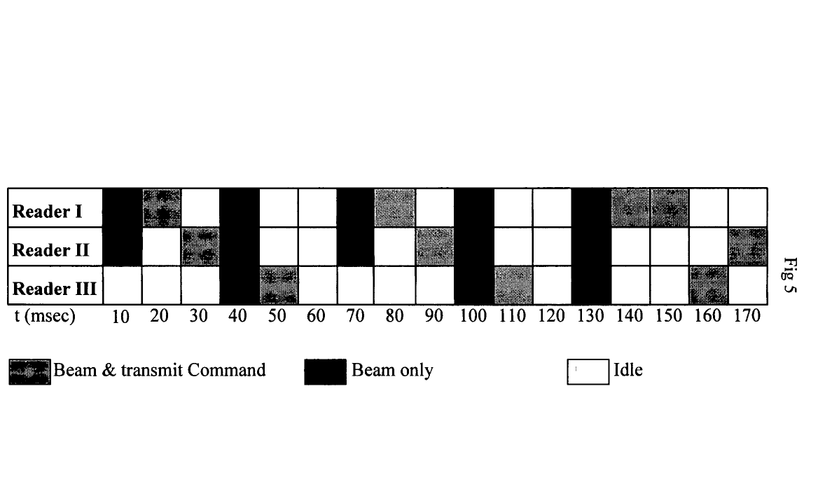

For the purpose of implementing the RFID TDM approach, each RFID reader is allocated a time slice and amplitude to use. FIG. 5 illustrates an example for such RFID TDM table of three RFID readers: Reader I, Reader II and Reader III, and each time slice is marked with its designated timing: 10 millisecond (msec), 20 msec, 30 msec and so on. In each time slice each RFID reader may be given permission to only transmit energy (beam) to the RFID tags in its vicinity, to transmit energy and send out commands or is ordered to remain idle. As the illustration shows, more then one RFID reader may be allocated transmission grants at the same time. The RFID TDM table is constantly managed by the system according to its needs and limitations. The RFID TDM mechanism may also include a learning algorithm which enables it to find the optimal RFID TDM table and enhance its communication abilities based on prior results. In addition to improving the reliability of the system, the RFID TDM algorithm allows RFID systems to be much more environmentally friendly, as it allows RFID operators to use substantially less RF radiation to achieve the same results.

According to a different embodiment of the present invention the system may utilize a frequency division multiplexing (FDM) algorithm. The RFID FDM algorithm allows dividing the RF frequency spectrum between different RFID readers and their corresponding RFID tags, whereas each RFID reader is using only its designated frequency slice. In order to implement RFID FDM algorithm, a designated middleware application dynamically define the frequency of use for the RFID readers. The middleware application implements RFID FDM algorithm allocations according to the optimization calculations performed by the algorithm. Similarly to the RFID TDM algorithm, the RFID FDM algorithm increases the transmission reliability of the RFID system while reducing costs and radiation pollution.

The system may enable its RFID readers to adjust their polarity according to the polarity of the RFID tags they are communicating with. Adjusting the polarity of the RFID readers may provide another method for preventing mutual interference between different RFID readers which simultaneously transmit commands. This method may be implemented when the system identifies the particular polarity of the RFID tags on a batch of items. Finding and retrieving the optimized polarities increases signal strength of targeted tags and decreases interference generated by tags that are not targeted. The result is similar to the results of RFID TDMA and FDM: higher reliability and accuracy at lower cost and lower radiation.

An additional method for optimizing the transference of commands from the RFID readers to the RFID tags relies on dividing particular operations between different RFID readers. For example, when the system is initiating a procedure of identifying the RFID tags, certain RFID readers may send the command for triggering a response from the RFID tags, while the others collect the incoming signals. Similarly, instead of using a single RFID reader to execute a long sequence of read-write operations, several RFID readers may be used to perform segments of that operation. Thus a sequence of write-verify-lock commands may be performed by three different RFID readers instead of only one. This method of operation may yield much better results and a more efficient operation of the RFID system. The system may also include a learning algorithm which enables it to dynamically select the optimal communication patterns in any given situation based on prior results.

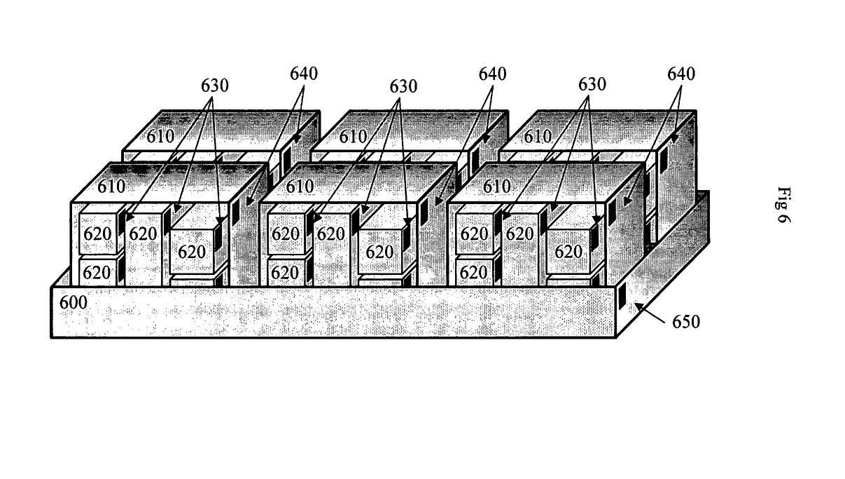

In addition, the system may also implement an innovative approach towards the organization of the RFID tags which may improve the efficacy of its operation. While according to prior art each RFID tag is an individual unit, the disclose RFID system enables arranging the RFID tags in hierarchical relations to each other. FIG. 6 illustrates an example of multi-tier tags in a logistics or retail environment. The illustration shows a three-tier environment in which each package 600 contains several kits 610, and each kit 610 contains several items 620. As with conventional RFID systems, a RFID tag is attached to each package 650, kit 640 and item 630. The proposed solution provides a means for exchanging information between the different tiers in the environment for the advantage of upper level applications. For this purpose read-write RFID tags are used to hold information about the tags which are in the preceding tier, thus the RFID tag of each kit 640 holds information about the RFID tags of the items 630 it contains, the RFID tag of each package 650 holds information about all the RFID tags of the kits 640 it contains and each master pack (not shown) holds information about all the RFID tags of the packages 650 it contains and so on. The information held by each RFID tag which is not at the leaf tier may be predetermined, or automatically updated by a middleware software according to authorized inventory events in its preceding tier. Such inventory events may include, for instance, the adding of items, the extracting of items, changes made in the position of items or any other relevant changes which are approved operations.

Implementing the hierarchical tag method has several advantages. It allows performing package integrity validations on the fly, at any location even with out upper level system connection and/or synchronization. The integrity validation is performed by a simple comparison between the actual content of a package with the information about its content held by the higher level RFID tag. For example, if a theft has occurred, or one element was misplaced without prior approval, this event will not cause an automatic update and the mismatch is identified at the first time the package enters an RFID domain. It also enables creating a tag directory system which significantly reduces searches for relevant information. Instead of searching through all the RFID tags in an area to find a particular one, the item may be searched for using the directory tree. At each step of the search only the tags of the relevant tier or branch may be activated, while all others are commanded to be silent. In addition, it allows performing certain operations, such as inventory checks, on the high-level tiers, without having to activate all RFID tags on all the items. This method may be used to efficiently check packaging integrity, reduce theft, and quickly locate items without depending on data which is commonly stored in the upper levels of the system.

The system may include methods for improving communication between the RFID readers and the RFID tags which are known to people who are skilled in the art. For instance the system may also identify the location of a particular RFID tag according to its transmission characteristics as they are received by at least three different RFID readers.

The disclosed embodiments of the RFID system allow it to implement advance security measures which increase its reliability and protect its information. These security measures may include the creation of RFID TDM tables with pseudo random idle slots as well as noise generation units which transmit false RFID responses, similar to those of RFID tags, during the said pseudo random idle slots. Each unit includes a control interface and a control protocol, and its operation is controlled by the central software component. Additionally, the system may also encrypt the communication between the RFID readers and the RFID tags. The purpose of such means is to obstruct any unauthorized intrusions and eavesdropping.

Additional security means may also include extensive privacy protection abilities. Such abilities give the end users the means for determining who may identify/read/write information on the tags, if any. Users are granted comprehensive control abilities, thus they may distinguish between different entities, and for example, it may allow one entity to only identify RFID tags while another may identify and read. According to prior art, users can only “kill” a tag—render it inoperable. The organization operating the RFID system may also implement a multi-level authentication mechanism. This mechanism allows the organization to define levels of authentication, permitting users to identify/read/write tags only according to their authentication level

While the preferred embodiment of the present invention includes all of the above-mentioned subsystems, other embodiments may be comprised of particular configurations of the proposed capabilities. In addition, while the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A system for managing radio frequency identification (RFID) elements communicating with RFID readers, said system comprised of:
an on-site software component residing on a computing device for centralizing real time communication between RFID readers in a single geographic location, wherein said communication includes collecting and integrating all data gathered by said RFID readers;
An interface module enabling users to communicate directly with the RFID tags through the on-site software component independent of the activation of any specific reader.

2. The system of claim 1 further comprising a control module for dynamic real time synchronization between RFID readers.

3. The system of claim 1 further comprising a logical layer module which holds updated information of RFID elements data status and activities of both communicable and incommunicable RFID elements.

4. The system of claim 1 wherein the on-site module further controls command transference characteristics of the RFID readers to optimize the operation of the local RFID system.

5. The system of claim 1 further comprising a central server which communicates with at least one central computing device, wherein each central computing device manages the RFID elements located at different geographic locations (domains), said central server enabling the management and control of all RFID data as represented in the logical layer.

6. The system of claim 3 wherein the logical layer module further includes virtual memory representing extended memory of read write RFID tags.

7. The system of claim 3 wherein the logical layer module further includes command buffering algorithm enabling the control of the transmission of commands to the RFID tags in accordance with configured conditions for ensuring the arrival of commands to the RFID tags.

8. The system of claim 2 further including a designated RFID time division multiplexing (FDM) communication module for managing the communication of the RFID readers.

9. The system of claim 2 further including a designated RFID frequency division multiplexing (FDM) communication module for managing the communication of the RFID readers.

10. The system of claim 8 wherein the algorithm is implemented by a designated middleware module which dynamically defines the timing of the RFID readers, in accordance with optimization calculations.

11. The system of claim 9 wherein the algorithm is implemented by a designated middleware module which dynamically defines the frequency of use for the RFID readers, in accordance with optimization calculations.

12. The system of claim 1 further comprising a polarity adjustment module for preventing mutual interference between different RFID readers.

13. The system of claim 1 wherein the on-site software module further includes an allocation module for dividing particular operations between the different RFID readers, wherein each reader performs a segment of the operation.

14. The system of claim 13 wherein the allocation module is based on a learning algorithm for dynamically selecting optimal communication patterns in any given situation.

15. The system of claim 1 further comprising an organization module which defines hierarchical relations between the RFID elements, wherein the hierarchical relations represent logical relations between the objects to which the RFID elements are attached.

16. The system of claim 15 wherein the RFID elements at the upper levels of the hierarchical relations are enabled to automatically store data relating to lower level RFID elements associated with the upper level RFID elements.

17. The system of claim 16 wherein RFID elements which store information of the lower level elements can be updated with data by a designated module.

18. The system of claim 1 further including a security module for encrypting the communication between the RFID readers and RFID tags.

19. The system of claim 1 further including an intrusion detection module for an automatic detection of unauthorized operations of RFID readers in the region.

20. The system of claim 1 further including an intrusion prevention module for an automatic prevention of unauthorized operations of RFID readers in the region.

21. The system of claim 18 wherein the security module enables defining a multi-level authorization procedure for the communication between the RFID readers and the RFID tags.

22. A method for managing radio frequency identification (RFID) tags communicating with RFID readers, said method comprising the steps of:
centralizing real time communication between RFID readers in a single geographic location;
collecting and integrating all data gathered by said RFID readers.

23. The method of claim 22 further comprising the step of holding updated information of RFID elements data status and activities of both communicable and incommunicable RFID elements.

24. The method of claim 22 further comprising the step of dynamically synchronizing in real time between the RFID readers.
